(19) United States
(12) Patent Application Publication
(10) Pub. No.: US 2023/0286555 A1
(43) Pub. Date: Sep. 14, 2023

(54) Railyard Switch Run Through Electronic Detection and Alarm System

(71) Applicant: Pillar Innovations, LLC, Grantsville, MD (US)

(72) Inventors: Avery Simon, Morgantown, WV (US); Edward L. Gibson, Jr., Morgantown, WV (US)

(21) Appl. No.: 18/119,893

(22) Filed: Mar. 10, 2023

Related U.S. Application Data
(60) Provisional application No. 63/318,940, filed on Mar. 11, 2022.

(51) Int. Cl. B61L 1/06; G01L 1/04; G08B 21/18

(52) U.S. Cl. CPC B61L 1/06; G01L 1/04; G08B 21/18

(57) ABSTRACT

A railyard switch run through (SRT) detection system includes at least one sensor, a detection node in communication with the at least one sensor, where the detection node includes a microcontroller and a power source, and an alert station in communication with the detection node. The alert station includes an indicator and a power source, where the detection node, based on data from the at least one sensor, is configured to detect an SRT event and activate the indicator of the alert station.

### CROSS-REFERENCE TO RELATED APPLICATION

This application claims priority to U.S. Provisional Application No. 63/318,940, filed Mar. 11, 2022, which is hereby incorporated by referenced in its entirety.

### BACKGROUND OF THE INVENTION

### Field of the Invention

The present disclosure relates to a railyard switch run through electronic detection and alarm system.

### Description of Related Art

Railyard switch run through (SRT) events occur in railyards during switching operations within the railyard. An SRT event occurs when a train passes through a switch, generally from the crossover or frog side of the switch, and the switch is misaligned with the direction of train travel. Switch stands, such as non-trailable-type switch stands, are rigid, robust mechanical devices that maintain the direction of the points of the switch. When an SRT occurs, the switch stand components are damaged, connecting rods may be bent during compression type SRT events, and the switch stand gears may be torn out during tension type SRT events. If an SRT event goes undetected and the train operator reverses direction of the train through the switch, the indeterministic state of the switch can cause a derailment within the railyard causing significant repair costs, labor costs, cleanup costs, and production down time. One solution has been to use a trailable-type switch, which is sometimes referred to as a flop switch. A trailable-type switch will automatically direct the points of the misaligned switch in the direction of travel of the train, which prevents damage to the switch, but can leave the switch set in a direction opposite to the original setting of the switch. Some rail operators do not approve of trailable-type switches and continue to use non-trailable-type switches in their railyards.

### SUMMARY OF THE INVENTION

In one aspect or embodiment, a railyard switch run through (SRT) detection system includes at least one sensor, a detection node in communication with the at least one sensor, with the detection node including a microcontroller and a power source, and an alert station in communication with the detection node. The alert station includes an indicator and a power source where the detection node, based on data from the at least one sensor, is configured to detect an SRT event and activate the indicator of the alert station.

The at least one sensor may include a plurality of strain gauges. The detection node may include an analog front end controller having an analog to digital converter, with the at least one sensor connected to the analog to digital converter and the analog to digital converter connected to the microcontroller. The analog front end controller may include a temperature sensor input. The power source of the detection node may include at least one of a battery and a solar panel. The power source of the alert station may include at least one of a battery and a solar panel. The system may include a plurality of detection nodes in communication with the alert station. The detection node may be wirelessly connected to the alert station. The indicator of the alert station may include at least one of a light and a horn. The alert station may be configured to be in communication with a local network and/or cloud. The detection node may include an alarm indicator configured to provide an indication once the SRT event is detected.

The detection node may include an enclosure, an installation bracket, and an antenna for wireless communication with the alert station, with the microcontroller received within the enclosure and the installation bracket connected to the enclosure and configured to secure the detection node to an object or ground surface.

In one aspect or embodiment, a railyard switch run through (SRT) detection system includes at least one sensor and a detection node in communication with the at least one sensor. The detection node includes a microcontroller, an analog front end controller, and a power source. The analog front end controller includes an analog to digital converter, with the at least one sensor connected to the analog to digital converter and the analog to digital converter connected to the microcontroller. The detection node, based on data from the at least one sensor, is configured to detect an SRT event.

In a further aspect or embodiment, a method of detecting a railyard switch run through (SRT) event includes: attaching at least one strain gauge to a component of a railyard switch stand; connecting the at least one strain gauge to a detection node; transmitting data from the at least one strain gauge to the detection node; and identifying the SRT event using a processor by comparing data from the at least one strain gauge to baseline stain gauge data for switch traffic and position changes.

The method may further include providing an alert indication of the SRT event.

### BRIEF DESCRIPTION OF THE DRAWINGS

The above-mentioned and other features and advantages of this disclosure, and the manner of attaining them, will become more apparent and the disclosure itself will be better understood by reference to the following descriptions of embodiments of the disclosure taken in conjunction with the accompanying drawings, wherein:

FIG. 1 is a schematic view of a SRT detection system according to one aspect or embodiment of the present application;

FIG. 2 is a perspective view of a detection node of the system of FIG. 1, showing the detection node installed adjacent to a railyard switch;

FIG. 3 is a perspective view of strain gauges of the system of FIG. 1, showing the strain gauges installed on a component of a railyard switch;

FIG. 4 is a perspective view of an alert station of the system of FIG. 1, showing the alert station installed in a railyard;

FIG. 5 is a schematic view of the detection node of FIG. 2 according to one aspect or embodiment of the present application;

FIG. 6 is a front view of the detection node of FIG. 2;

FIG. 7 is a side view of the detection node of FIG. 2;

FIG. 8 is a schematic view of the detection node of FIG. 2 according to one aspect or embodiment of the present application;

FIG. 9 is a schematic view of a firmware flow chart for the detection node of FIG. 2 according to one aspect or embodiment of the present application;

FIG. 10 is a graph of data from a strain gauge during an SRT event;

FIG. 11 is a graph of data from a strain gauge during a switch position change; and

FIG. 12 is a graph of data from a strain gauge during normal switch traffic.

Corresponding reference characters indicate corresponding parts throughout the several views. The exemplifications set out herein illustrate exemplary embodiments of the disclosure, and such exemplifications are not to be construed as limiting the scope of the disclosure in any manner.

### DETAILED DESCRIPTION OF THE INVENTION

Spatial or directional terms, such as “left”, “right”, “inner”, “outer”, “above”, “below”, and the like, are not to be considered as limiting as the invention can assume various alternative orientations.

For purposes of the description hereinafter, the terms “upper”, “lower”, “right”, “left”, “vertical”, “horizontal”, “top”, “bottom”, “lateral”, “longitudinal”, and derivatives thereof shall relate to the invention as it is oriented in the drawing figures. However, it is to be understood that the invention may assume various alternative variations, except where expressly specified to the contrary. It is also to be understood that the specific devices illustrated in the attached drawings, and described in the following specification, are simply exemplary aspects of the invention.

Unless otherwise indicated, all ranges or ratios disclosed herein are to be understood to encompass the beginning and ending values and any and all subranges or subratios subsumed therein. For example, a stated range or ratio of “1 to 10” should be considered to include any and all subranges or subratios between (and inclusive of) the minimum value of 1 and the maximum value of 10; that is, all subranges or subratios beginning with a minimum value of 1 or more and ending with a maximum value of 10 or less.

The terms “first”, “second”, and the like are not intended to refer to any particular order or chronology, but refer to different conditions, properties, or elements.

As used herein, “at least one of” is synonymous with “one or more of”. For example, the phrase “at least one of A, B, and C” means any one of A, B, or C, or any combination of any two or more of A, B, or C. For example, “at least one of A, B, and C” includes one or more of A alone; or one or more of B alone; or one or more of C alone; or one or more of A and one or more of B; or one or more of A and one or more of C; or one or more of B and one or more of C; or one or more of all of A, B, and C.

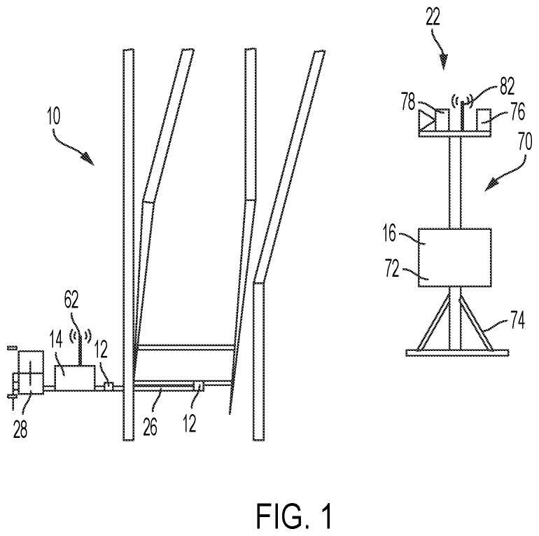

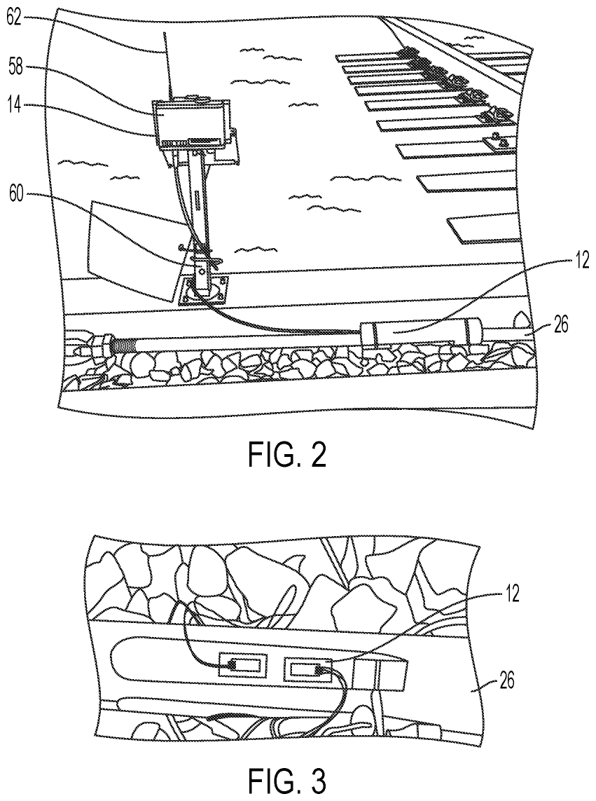

Referring to FIGS. 1-8, in one aspect or embodiment, an SRT detection system 10 includes a sensor(s) 12, a detection node 14 in communication with the sensor(s) 12, and an alert station 16 in communication with the detection node 14. The detection node 14 includes a microcontroller 18 and a power source 20. The alert station 16 includes an indicator 22 and a power source 24. The detection node 14, based on data from the sensor(s) 12, is configured to detect an SRT event and activate the indicator 22 of the alert station 16. The microcontroller 18 may include at least one processor, or any other like computing device for controlling one or more aspects of the system 10.

In one aspect or embodiment, the sensor(s) 12 includes a plurality of strain gauges. In one example, four strain gauges are provided and are configured to be attached to one or more components 26 of a railyard switch 28. The strain gauges may be connected to the railyard switch 28 via an adhesive, such as epoxy, although other suitable attachment arrangements may be utilized. Although the sensor(s) 12 are shown on top of a connecting rod in FIG. 3, one or more sensor(s) 12 may be positioned on the top of the connecting rod and one or more sensor(s) 12 may be positioned on a side of the connecting rod.

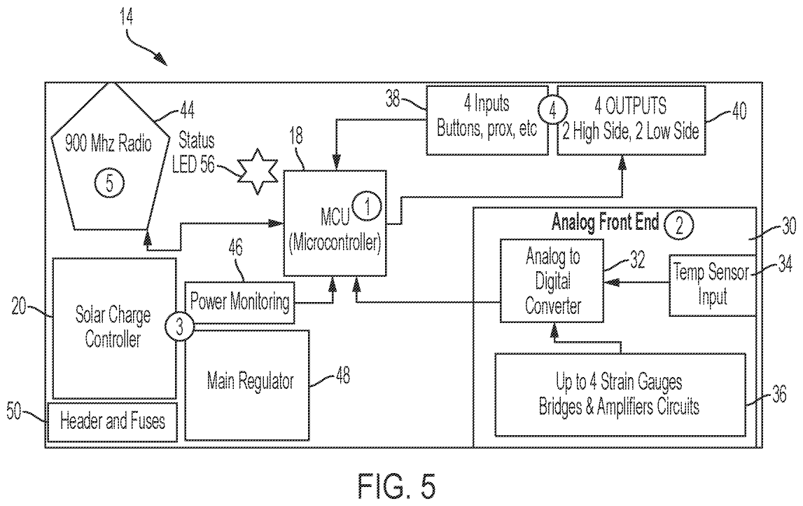

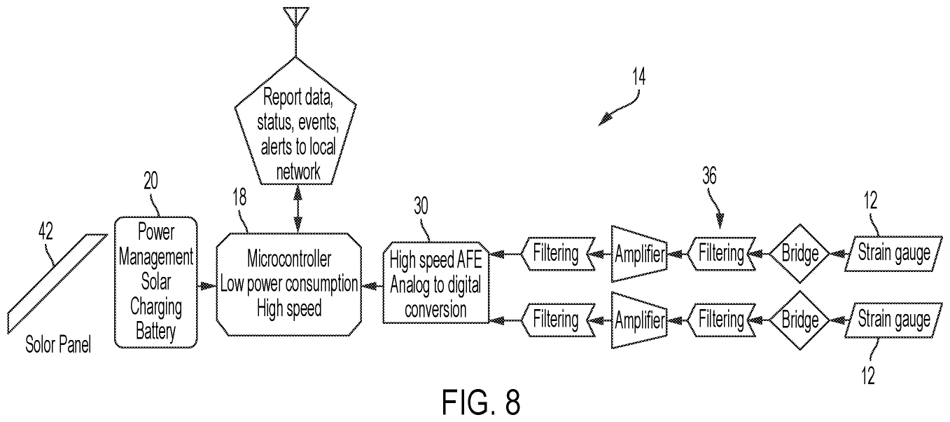

Referring to FIGS. 5 and 8, the detection node 14 includes an analog front end controller 30 having an analog to digital converter 32, with the sensor(s) 12 connected to the analog to digital converter 32 and the analog to digital converter 32 connected to the microcontroller 18. The analog front end controller 30 may include a temperature sensor input 34. The analog front end controller 30 and/or the sensor(s) 12 may include bridges and amplifiers circuits 36. In one aspect or embodiment, the detection node 14 includes four inputs 38 and four outputs 40. The detection node 14 may include an alert light output, a horn output, a reset/test button input, and a thermistor input, although other suitable configurations may be utilized. In one aspect or embodiment, the microcontroller 18 is configured for low power 80 μA per Mhz up to 48 Mhz. In one aspect or embodiment, the analog front end controller 30 is configured for simultaneous analog to digital conversion at 24 bit of 4 inputs at 8 ksps. The power source 20 of the detection node includes at least one of a battery and a solar panel 42. In one aspect or embodiment, the power source 20 of the detection node 14 includes a photovoltaic solar array and a lithium battery. The detection node 14 is wirelessly connected to the alert station 16. In one aspect or embodiment, the detection node 14 includes a radio module 44, such as a 900 Mhz radio module, for communication with the alert station 16. The detection node 14 includes a power monitoring circuit 46, a main regulator circuit 48, and a header and fuses circuit 50. The detection node 14 includes an alarm indicator 56 configured to provide an indication when the SRT event is detected. The alarm indicator 56 may be an LED light, although other suitable arrangements may be utilized. The alarm indicator 56 may also provide a status of the detection node 14. In one aspect or embodiment, the system 10 includes a plurality of detection nodes 14 in communication with the alert station 16. The alert station 16 may support up to 32 detection nodes 14 in a meshing network configuration or up to 255 detection nodes 14 if a meshing network is not required for the installation.

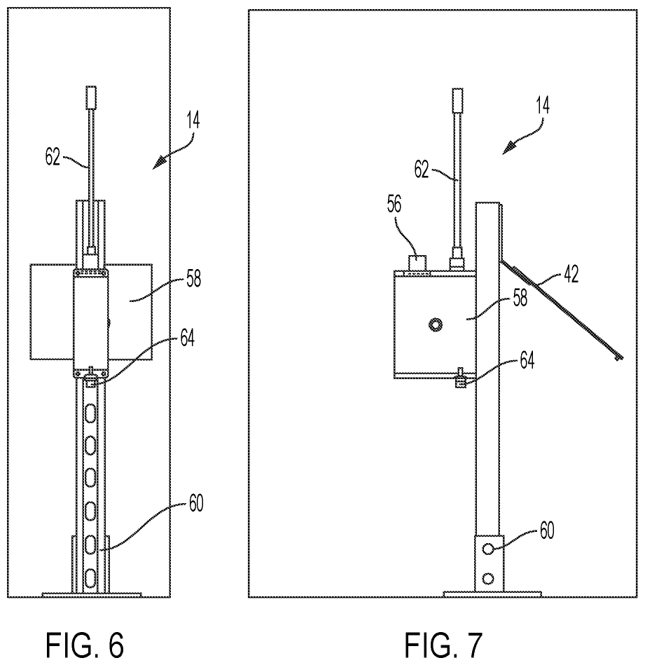

Referring to FIGS. 6 and 7, the detection node 14 includes an enclosure 58, an installation bracket 60, and an antenna 62 for wireless communication with the alert station 16. The microcontroller 18, the analog front end controller 30, the power monitoring circuit 46, the main regulator circuit 48, and the head and fuses circuit 50 are received within the enclosure 58. The installation bracket 60 is connected to the enclosure 58 and configured to secure the detection node 14 to an object or ground surface. The solar panel 42 is connected to and extends from the installation bracket 60. A reset/test button 64 is positioned outside of the enclosure 58. The installation bracket 60 may be formed from T-slot framing components.

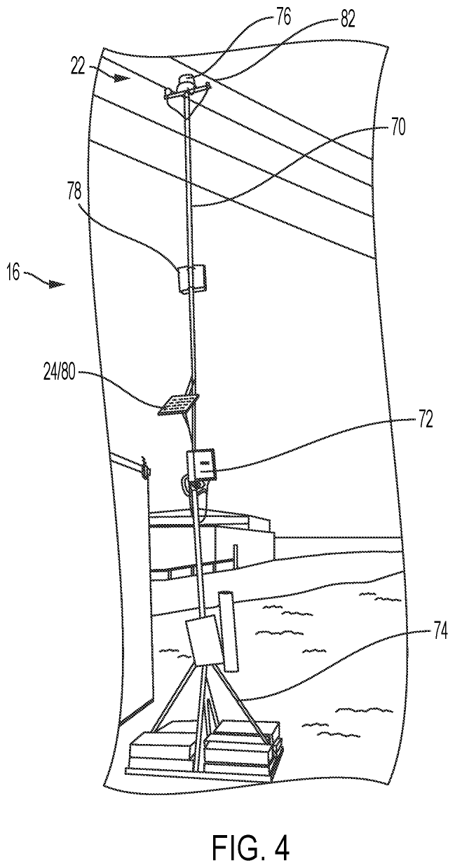

Referring to FIGS. 1 and 4, the alert station 16 further includes a mounting pole 70 and an enclosure 72. The mounting pole 70 may include support legs 74 to support the mounting pole 70 on a ground surface, although the mounting pole 70 may be fixed directly to a ground surface or an object. The indicator 22 of the alert station 16 includes at least one of a light 76 and a horn 78. In one aspect or embodiment, the indicator 22 of the alert station 16 includes an LED light beacon 76 and an industrial horn 78. The power source 24 of the alert station 16 may include at least one of a battery and a solar panel 80. In one aspect or embodiment, the power source 24 of the alert station 16 includes a photovoltaic solar array and a lithium battery. The alert station 16 may be in communication with the detection node(s) 14 via a radio module, such as a 900 Mhz radio module, having an antenna 82. The LED light beacon 76 and/or the horn 78 may be mounted at a top of the mounting pole 70 or closer to the top of the mounting pole 70 than a bottom of the mounting pole 70. The position of the LED light beacon 76 and/or the horn 78 may be adjustable along the length of the mounting pole 70. The alert station 16 is configured to be in communication with a local network and/or cloud. The alert station 16 is configured to process messages from the detection node(s) 14 to determine the message type. If an alarm message is received by the alert station 16, the alert station 16 is configured to activate the light 76 and the horn 78 local to the alert station 16 as well as send the alarm message data to a cloud-based monitoring platform to provide remote alarms via a webpage, email, and/or text message. The alert station 16 may include a microcontroller and/or processor (not shown).

In one aspect or embodiment, a method of detecting an SRT event includes: attaching the strain gauge(s) 12 to the component 26 of the railyard switch stand 28; connecting the strain gauge(s) 12 to the detection node 14; transmitting data from the strain gauge(s) 12 to the detection node 14; and identifying the SRT event using a processor by comparing data from the strain gauge(s) 12 to baseline stain gauge data for switch traffic and position changes. The method may further include providing an alert indication of the SRT event, such as by activating the light 76 and horn 78.

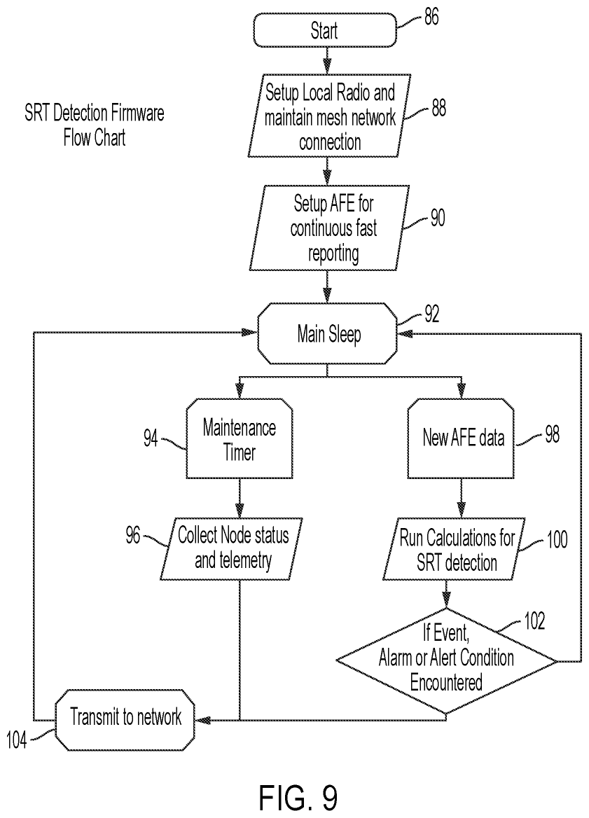

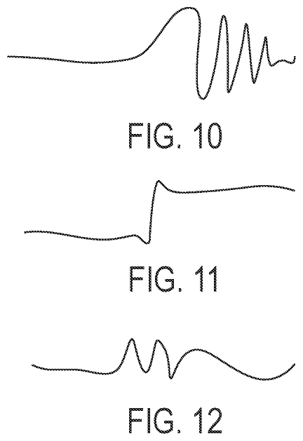

Referring to FIGS. 9-12, in one aspect or embodiment, data from the sensor(s) 12 is processed by the microcontroller 18 of the detection node(s) 14 to compare the incoming data to the baseline strain gauge data. An SRT event recognition algorithm is used to verify that the incoming data meets an SRT event signature that has been established through testing and monitoring of data during SRT events. As shown in FIG. 10, the stain gauge data during an SRT event displays a rapid buildup of strain to a release and then an oscillation. The oscillation occurs each time a wheel of a passing train passes the points of the railyard switch 28. The strain gauge data during an SRT event, as shown in FIG. 10, is measured against the baseline strain gauge data for switch position changes, as shown in FIG. 11, and normal traffic through the switch 28, as shown in FIG. 12. In one aspect or embodiment, the SRT event recognition algorithm keeps a long rolling average, keeps an instantaneous average (over a few ms of time), keeps a record of maximum and minimum of instantaneous averages during long rolling average period, calculates and keeps maximum delta between the maximum and minimum, detects several consecutive changes (peaks and valleys), and, if a maximum delta is above a threshold and multiple consecutive peaks and valleys have been detected, the system 10 triggers an alarm message. The SRT event detection firmware flow chart is shown in FIG. 9. The system 10 is initiated 86, local radio is established and mesh network connection is maintained 88, and the analog front end controller is initiated for continuous fast reporting 90. The microcontroller 18 includes a main sleep mode 92 with a maintenance timer 94 and associated collection of status and telemetry of the detection node(s) 96, which is subsequently transmitted to the alert station 16 and/or network. The microcontroller 18 also awakens upon receipt of new data 98 from the analog front end controller 30, runs calculations to identify if an SRT event occurred 100, and determines whether an SRT event occurs 102. If an SRT event occurs, the alarm message is transmitted to the alert station 16 and/or network to activate the light 76 and horn 78 and transmit the alarm message 104 to the local network and/or cloud.

Accordingly, the system 10 is configured to electronically monitor strain on the components of a railyard switch and process strain readings in real-time to determine excessive component stress caused by an SRT event. The system 10 is also configured to wirelessly transmit an alarm message to the alert station 16 to alert railyard operators of an SRT event with audible and/or visual indicators until the system 10 is reset. The system 10 is configured to be entirely self-powered.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. A railyard switch run through (SRT) detection system comprising:
at least one sensor;
a detection node in communication with the at least one sensor, the detection node comprising a microcontroller and a power source; and
an alert station in communication with the detection node, the alert station comprising an indicator and a power source, wherein the detection node, based on data from the at least one sensor, is configured to detect an SRT event and activate the indicator of the alert station.

2. The system of claim 1, wherein the at least one sensor comprises a plurality of strain gauges.

3. The system of claim 1, wherein the detection node comprises an analog front end controller comprising an analog to digital converter, the at least one sensor is connected to the analog to digital converter, and the analog to digital converter is connected to the microcontroller.

4. The system of claim 3, wherein the analog front end controller comprises a temperature sensor input.

5. The system of claim 1, wherein the power source of the detection node comprises at least one of a battery and a solar panel.

6. The system of claim 5, wherein the power source of the alert station comprises at least one of a battery and a solar panel.

7. The system of claim 1, further comprising a plurality of detection nodes in communication with the alert station.

8. The system of claim 1, wherein the detection node is wirelessly connected to the alert station.

9. The system of claim 1, wherein the indicator of the alert station comprises at least one of a light and a horn.

10. The system of claim 1, wherein the alert station is configured to be in communication with a local network and/or cloud.

11. The system of claim 1, wherein the detection node comprises an alarm indicator configured to provide an indication once the SRT event is detected.

12. The system of claim 1, wherein the detection node comprises an enclosure, an installation bracket, and an antenna for wireless communication with the alert station, the microcontroller received within the enclosure, the installation bracket is connected to the enclosure and configured to secure the detection node to an object or ground surface.

13. A railyard switch run through (SRT) detection system comprising:
at least one sensor; and
a detection node in communication with the at least one sensor, the detection node comprising a microcontroller, an analog front end controller, and a power source, the analog front end controller comprising an analog to digital converter, with the at least one sensor connected to the analog to digital converter and the analog to digital converter connected to the microcontroller, wherein the detection node, based on data from the at least one sensor, is configured to detect an SRT event.

14. A method of detecting a railyard switch run through (SRT) event, the method comprising:
attaching at least one strain gauge to a component of a railyard switch stand;
connecting the at least one strain gauge to a detection node;
transmitting data from the at least one strain gauge to the detection node; and
identifying the SRT event using a processor by comparing data from the at least one strain gauge to baseline stain gauge data for switch traffic and position changes.

15. The method of claim 14, further comprising: providing an alert indication of the SRT event.
